(19) United States
(12) Patent Application Publication
(10) Pub. No.: US 2009/0193355 A1
(43) Pub. Date: Jul. 30, 2009

(54) INFORMATION PROCESSING APPARATUS AND DISPLAY CONTROL METHOD

(75) Inventor: Masahiro Tada, Tachikawa-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/249,713

(22) Filed: Oct. 10, 2008

(30) Foreign Application Priority Data
Jan. 25, 2008 (JP) 2008-015118

(51) Int. Cl. G06F 3/048

(52) U.S. Cl. 715/790; 715/788

(57) ABSTRACT

According to one embodiment, an information processing apparatus includes a storage unit which stores a first program for playing back video data and a second program different from the first program, an execution unit which executes the first program and the second program, a display unit which displays, on a display device, a window generated by the first program and a window generated by the second program, and a change unit which, upon detecting a predetermined scene in a video picture played back by the first program, causes the display unit to display the window of the first program with higher priority over the window of the second program.

### CROSS-REFERENCE TO RELATED APPLICATIONS

This application is based upon and claims the benefit of priority from Japanese Patent Application No. 2008-015118, filed Jan. 25, 2008, the entire contents of which are incorporated herein by reference.

### BACKGROUND

1. Field

One embodiment of the present invention relates to a display control technique and, more particularly, to an information processing apparatus and a display control method, which make it possible to control a display window upon detecting a specific scene.

2. Description of the Related Art

A technique of changing the operation in accordance with the contents of a moving picture displayed on, e.g., a personal computer by a moving picture display program is generally disclosed. For example, Jpn. Pat. Appln. KOKAI Publication No. 2005-354148 discloses a technique of recording a moving picture displayed in a window at a high picture quality if its contents have a high priority for the user or at a low picture quality if the contents have a low priority for the user.

However, when a moving picture display program is displayed in a window, the technique described in Jpn. Pat. Appln. KOKAI Publication No. 2005-354148 cannot change the operation of the window in accordance with the contents of the moving picture displayed in the window.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view schematically showing an example of the arrangement of an information processing apparatus according to an embodiment of the present invention;

FIG. 2 is an exemplary block diagram showing the arrangement of the information processing apparatus according to the embodiment;

FIG. 3 is an exemplary block diagram showing the functional arrangement of a video playback application of the information processing apparatus according to the embodiment;

FIG. 4 is an exemplary block diagram for explaining the outline of the display control method of the information processing apparatus according to the embodiment;

FIG. 5 is an exemplary flowchart for explaining the display control method of the information processing apparatus according to the embodiment;

FIG. 6 is an exemplary conceptual view showing a state in which the priority order of the window of the information processing apparatus according to the embodiment is changed;

FIG. 7 is an exemplary conceptual view showing a state in which the priority order of the window of the information processing apparatus according to the embodiment is changed;

FIG. 8 is an exemplary conceptual view showing a state in which the size of the window of the information processing apparatus according to the embodiment is changed; and

FIG. 9 is an exemplary conceptual view showing a state in which the size of the window of the information processing apparatus according to the embodiment is changed.

### DETAILED DESCRIPTION

Various embodiments according to the invention will be described hereinafter with reference to the accompanying drawings. In general, according to one embodiment of the Invention, an information processing apparatus includes: a storage unit which stores a first program for playing back video data and a second program different from the first program; an execution unit which executes the first program and the second program; a display unit which displays, on a display device, a window generated by the first program and a window generated by the second program; and a change unit which, upon detecting a predetermined scene in a video picture played back by the first program, causes the display unit to display the window of the first program with higher priority over the window of the second program.

The embodiment of the present invention will now be described with reference to the accompanying drawing.

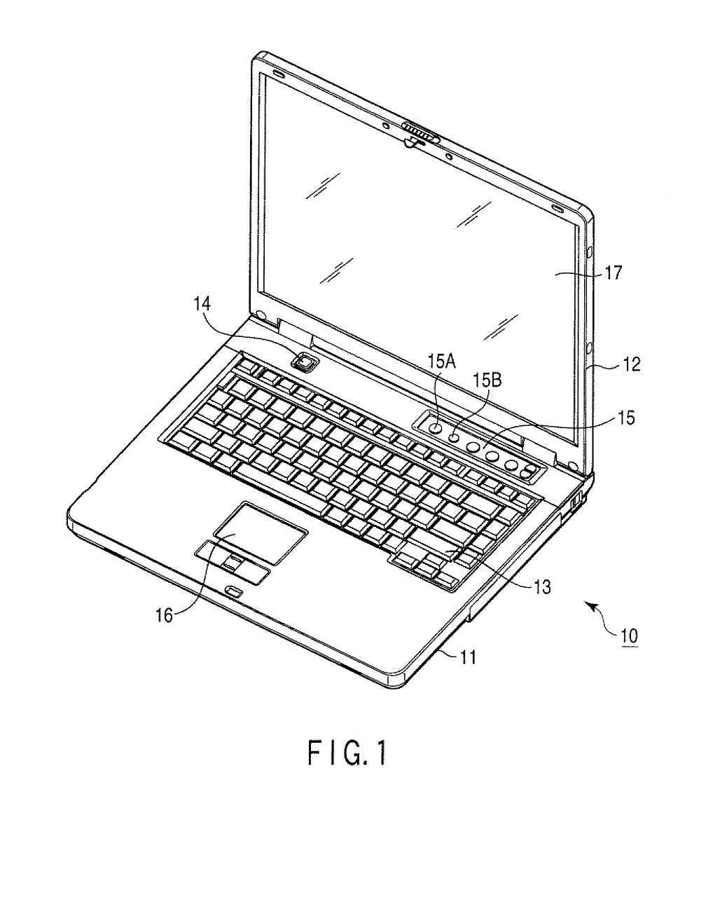

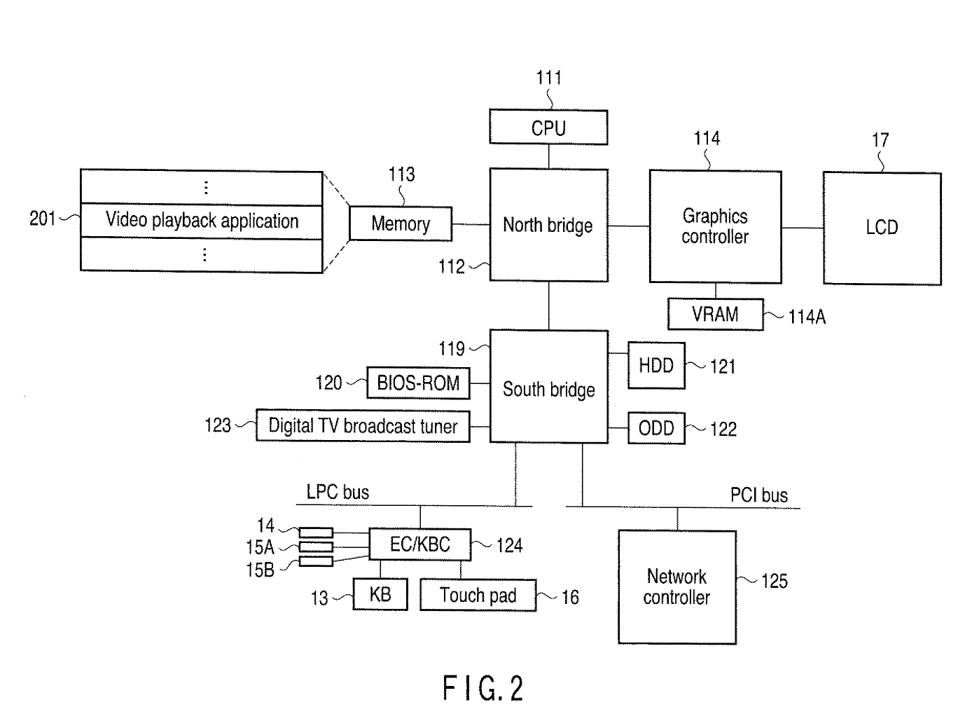

First, the arrangement of an information processing apparatus according to an embodiment of the present invention will be explained with reference to FIGS. 1 and 2. The information processing apparatus is implemented as, e.g., a notebook personal computer 10.

FIG. 1 is a perspective view showing a state in which the display unit of the notebook personal computer 10 is open. The computer 10 includes a computer main body 11 and a display unit 12. The display unit 12 has a built-in display device formed from a liquid crystal display (LCD) 17. The display screen of the LCD 17 is located almost at the center of the display unit 12.

The display unit 12 is attached to the computer main body 11 to freely pivot between the open position and the close position. The computer main body 11 has a thin box-shaped housing and includes, on its upper surface, a keyboard 13, a power button 14 to power on/off the computer 10, an input operation panel 15, and a touchpad 16.

The input operation panel 15 is an input device that inputs an event corresponding to a pressed button to the system. The input operation panel 15 has a plurality of buttons to activate a plurality of functions. The button group includes a TV activation button 15A and a Digital Versatile Disc (DVD) activation button 15S. The TV activation button 15A is a button to activate a TV function of playing back and recording broadcast program data such as a digital TV broadcast program. When the user presses the TV activation button 15A, a TV application program for executing the TV function is activated. The DVD activation button 15B is a button to play back video content recorded on a DVD. When the user presses the DVD activation button 15B, an application program for playing back video content is automatically activated.

The system configuration of the computer 10 will be described next with reference to FIG. 2.

As shown in FIG. 2, the computer 10 includes a CPU 111, north bridge 112, main memory 113, graphics controller 114, south bridge 119, BIOS-ROM 120, hard disk drive (HOD) 121, optical disk drive (ODD) 122, digital TV broadcast tuner 123, embedded controller/keyboard controller IC (EC/KBO) 124, and network controller 125.

The CPU 111 is a processor provided to control the operation of the computer 10 and executes an operating system (OS) and various application programs such as a video playback application 201, which are loaded from the hard disk drive (HDD) 121 to the main memory 113.

The CPU 111 also executes a system basic input/output system (BIOS) stored in the BIOS-ROM 120. The system BIOS is a program for hardware control.

The north bridge 112 is a bridge device for connecting the local bus of the CPU 111 to the south bridge 119. The north bridge 112 incorporates a memory controller to control access to the main memory 113. The north bridge 112 also has a function of executing communication with the graphics controller 114 via an Accelerated Graphics Port (APG) bus or the like.

The graphics controller 114 is a display controller that controls the LCD 17 serving as the display monitor of the computer 10. The graphics controller 114 generates, from picture data written in a video memory (VRAM) 114A, a display signal to be sent to the LCD 17.

The south bridge 119 controls devices on a Low Pin Count (LPC) bus and devices on a Peripheral Component Interconnect (PCI) bus. The south bridge 119 incorporates an Integrated Drive Electronics (IDE) controller to control the HDD 121 and the ODD 122. The south bridge 119 also has a function of controlling the digital TV broadcast tuner 123 and a function of controlling access to the BIOS-ROM 120.

The HOD 121 is a storage device for storing various kinds of software and data. The optical disk drive (ODD) 122 is a drive unit to drive a storage medium such as a DVD storing video content. The digital TV broadcast tuner 123 is a reception unit to externally receive broadcast program data such as a digital TV broadcast program.

The embedded controller/keyboard controller IC (EC/KBC) 124 is an one-chip microcomputer on which an embedded controller for power management and a keyboard controller to control the keyboard (KB) 13 and the touchpad 16 are integrated. The embedded controller/keyboard controller IC (EC/KBC) 124 has a function of powering on/off the computer 10 as the user operates the power button 14. The embedded controller/keyboard controller IC (EC/KBC) 124 can also power on the computer 10 as the user operates the TV activation button 15A or DVD activation button 15B. The network controller 125 is a communication unit which executes communication with an external network such as the Internet.

The video playback application 201 is a software to decode and play back moving picture data that is compression-coded. The video playback application 201 has a software decoder supporting the MPEG-2 standard, H.264/AVC standard or the like. The video playback application 201 has a function of decoding a moving picture stream (e.g., a digital TV broadcast program received by the display unit 123 or video content complying with a high-definition (HD) standard read from the optical disk drive (ODD) 122) compression-coded by an encoding method defined by the H.264/AVC standard. The video playback application 201 can perform window display as well as full screen display.

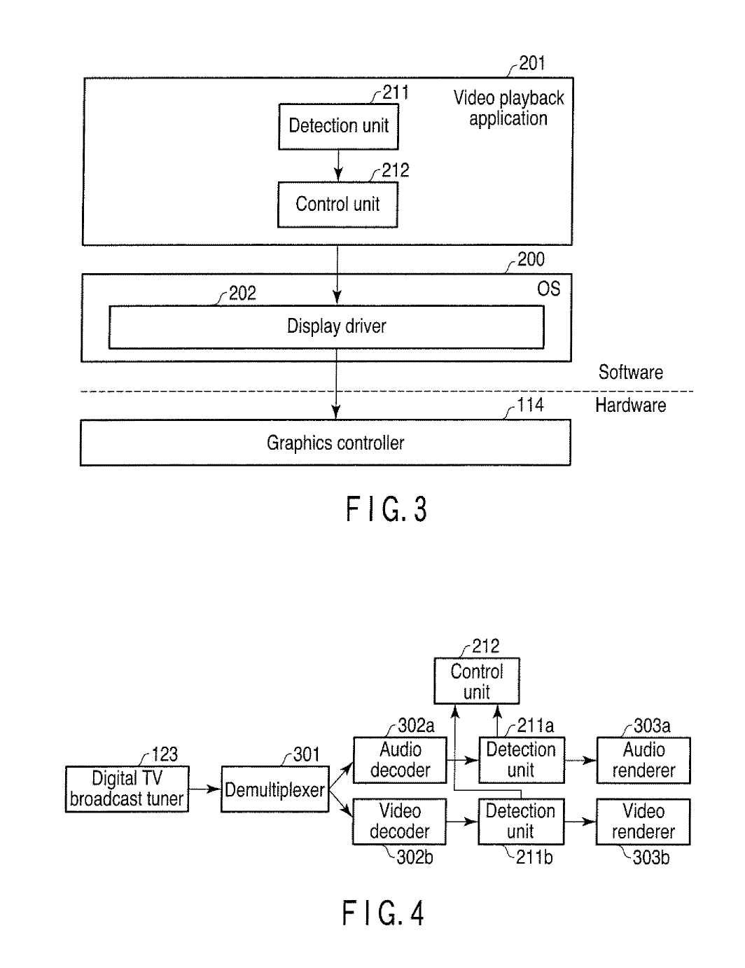

As shown in FIG. 3, the video playback application 201 has a detection unit 211 and a control unit 212.

When decoding a moving picture, the detection unit 211 detects a predetermined scene such as a commercial in the moving picture data. When the detection unit 211 detects a specific scene, the control unit 212 controls the priority order (Z-order) of overlap of the window of the video playback application 201 or the size of the window. The control unit 212 requests OS 200 to control the window. Upon the request OS reorders windows and updates the desktop image that is transmitted to the graphics controller 114 via a display driver 202.

The outline of a display control method using the information processing apparatus according to the embodiment of the present invention will be described next with reference to FIG. 4.

For example, content received via the digital TV broadcast tuner 123 is separated into audio data and moving picture data by a demultiplexer 301. An audio decoder 302a and a video decoder 302b decode these data, respectively. When detection units 211a and 211b for detecting a specific scene detect a commercial, a cheer, a person, or the like from the decoded moving picture data and audio data, the control unit 212 controls the window of the video playback application 201. An audio renderer 303a and a video renderer 303b output the audio data and moving picture data to the controlled window.

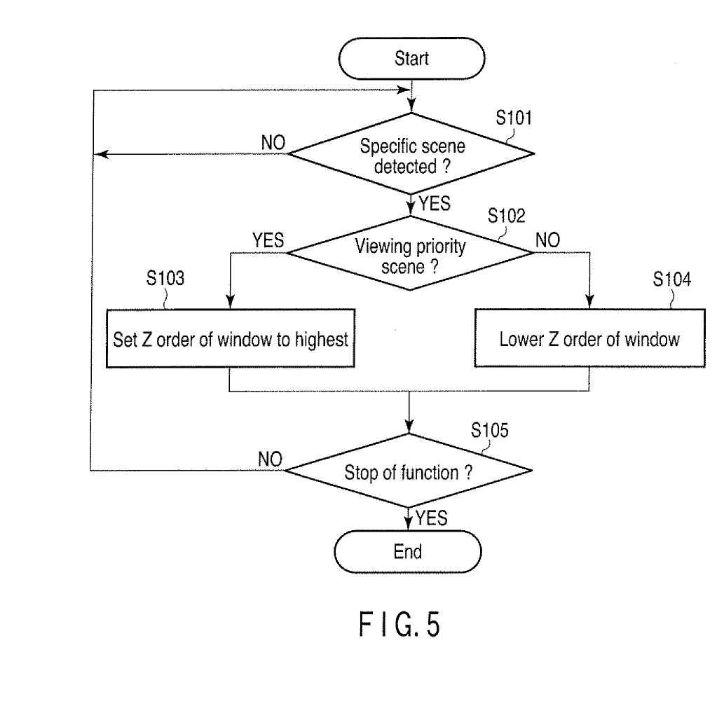

The display control method using the information processing apparatus according to the embodiment of the present invention will be described next with reference to the flowchart in FIG. 5.

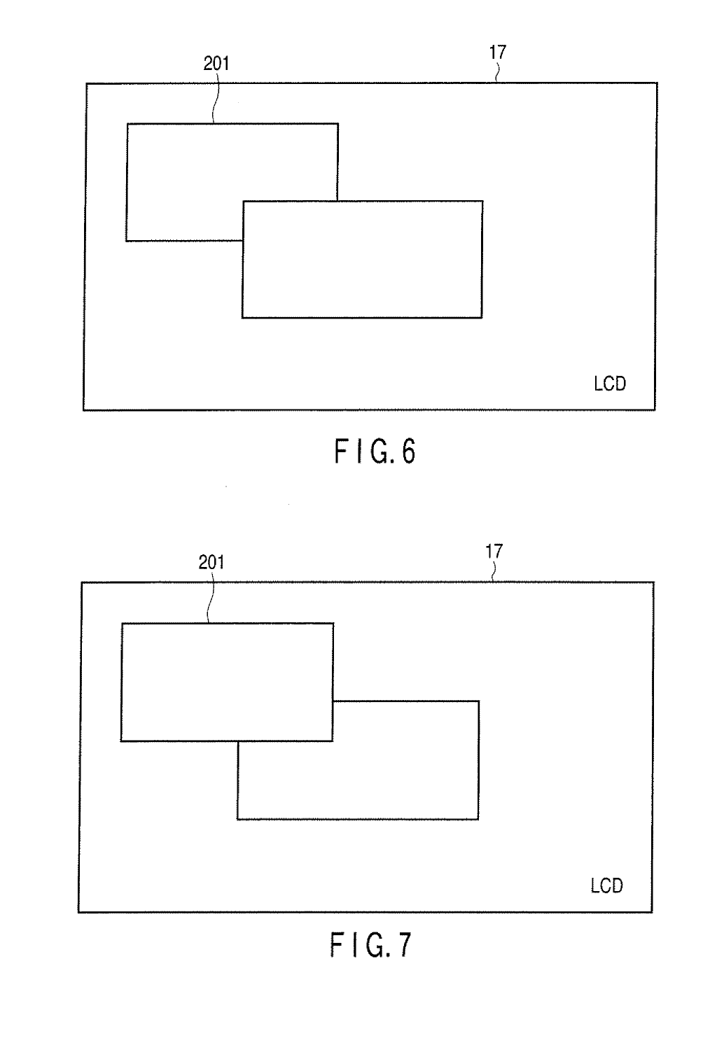

The video playback application 201 determines whether a preset specific scene such as a commercial is displayed (detected) (block S101). If the video playback application 201 determines that a preset specific scene is displayed (detected) (YES in block S101), the video playback application 201 determines whether the scene detected in block S101 is a viewing priority scene (block S102). If the video playback application 201 determines that the scene is a viewing priority scene (e.g., a non-commercial scene) (YES in block S102), the Z-order of the window that is displaying the video playback application 201 is set to the highest to move the window to the top of the stack (the state in FIG. 6 is changed to that in FIG. 7).

On the other hand, if the video playback application 201 determines that the scene is not a viewing priority scene (NO in block 5102), the Z-order of the window that is displaying the video playback application 201 is lowered to move the window behind the top of the stack (the state in FIG. 7 is changed to that in FIG. 6).

The viewing priority scene is, e.g., a scene desired by the user in a TV program that is on the air (or recorded). Examples are a part except commercials (the main part of a program), a scene with a cheer in a TV program, and a scene where a user's favorite person appears. Various scenes can be detected using the determination in steps S101 and S102. For example, “the end of a commercial is detected in block S101, the main part of a TV program starts, and a scene with a cheer is then detected in block S102”. Alternatively, “the start of a commercial is detected in block S101, the commercial starts, and a favorite person is then detected in block S102”.

Note that a commercial section in a recorded TV program (including a TV program played back by chasing playback) can be detected by, e.g., the following method. In Japan, a broadcast program normally includes short silent sections before and after a commercial. Additionally, the length of a commercial is a multiple of 15 seconds. Using these characteristics, if the insertion interval of silent sections is a multiple of a predetermined time, the section can be detected as a commercial section. In watching an on-air TV program with a main part in stereo sound, the interval of silent sections needs to be detected. To do this, the TV program is recorded for, e.g., about 60 seconds, and the recorded data of 60 seconds is analyzed, thereby detecting a commercial section. If the main part of a TV program is not in stereo sound, switching between a commercial (stereo sound) and the main part (mono sound) can be detected based on the change of the audio mode.

Detection of a specific person can be implemented by calculating in advance the feature amounts of the facial image of a person registered beforehand and comparing the feature amounts with those of a facial image included in the playback picture. The volume of a cheer can be detected by detecting the volume of decoded audio data.

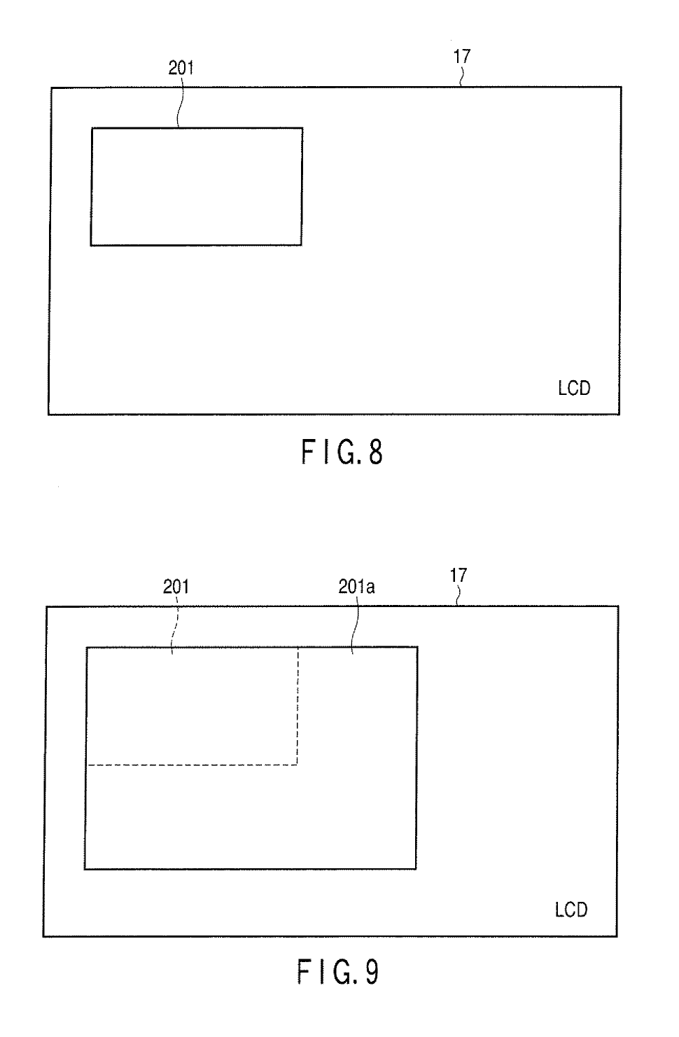

In the above-described embodiment, the priority order of overlap of the window of the video playback application 201 is changed upon detecting a specific scene. Instead, the window size may be changed. Assume that the window of the video playback application 201 is displayed on the LCD 17 as shown in FIG. 8. When a specific scene is detected and determined as a viewing priority scene, the size of the window 201 is made large (including full, screen display) to display a window 201a, as shown in FIG. 9. On the other hand, if the scene is not determined as a viewing priority scene, the size of the window 201a may be reduced to display the window 201, as shown in FIG. 9.

It is an object of the present invention to provide an information processing apparatus and a display control method which make it possible to change the operation of a window in accordance with the contents of a moving picture to be played back when a program for playing back a moving picture is displayed in a window.

Note that the present invention is not exactly limited to the above embodiments, and constituent elements can be modified in the execution stage without departing from the spirit and scope of the invention.

Various inventions can be formed by properly combining a plurality of constituent elements disclosed in the above embodiments. For example, several constituent elements may be omitted from all the constituent elements described in the embodiments. In addition, constituent elements throughout different embodiments may be properly combined.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a storage module to store a first program for playing back video data and a second program different from the first program;
an execution module to execute the first program and the second program;
a display module to display, on a display device, a window generated by the first program and a window generated by the second program; and
a change module which, upon detecting a predetermined scene in a video picture played back by the first program, cause the display module to display the window of the first program with higher priority over the window of the second program.

2. The apparatus of claim 1, wherein upon detecting the predetermined scene in the video picture played back by the first program, the display module displays the window of the second program with higher priority over the window of the first program.

3. The apparatus of claim 1, wherein upon detecting the predetermined scene in the video picture played back by the first program, the display module changes a size of the window of the first program.

4. An information processing apparatus comprising:
a storage module to store a first program for playing back video data and a second program different from the first program;
an execution module to execute the first program and the second program;
a display module to display, on a display device, a window generated by the first program and a window generated by the second program; and
a change module which, upon detecting a predetermined scene in a video picture played back by the first program, causes the display module to change a size of the window of the first program.

5. A display control method used by an information processing apparatus capable of displaying windows of a plurality of programs, comprising:
storing, in a storage module, the plurality of programs including a content playback program for displaying content;
reading the plurality of programs including the content playback program from the storage module and displaying the windows of the programs; and
upon detecting a predetermined scene in content displayed by the content playback program, changing a priority order of display setting of the window of the content playback program in the windows of the plurality of programs displayed on a display module.

6. The method of claim 5, wherein the display setting of the window of the content playback program is a predetermined setting, a priority order of overlap of window display is changed.

7. The method of claim 5, wherein the display setting of the window of the content playback program is a predetermined setting, a size of window display is changed.
